(19) United States
(12) Patent Application Publication
(10) Pub. No.: US 2021/0277659 A1
(43) Pub. Date: Sep. 9, 2021

(54) AWNING BAR AND PROJECTOR SYSTEM

(71) Applicants: Jake Kalil, Colonie, NY (US); Peter Kalil, Schenectady, NY (US)

(72) Inventors: Jake Kalil, Colonie, NY (US); Peter Kalil, Schenectady, NY (US)

(21) Appl. No.: 17/222,462

(22) Filed: Apr. 5, 2021

Related U.S. Application Data
(63) Continuation of application No. PCT/US2021/020807, filed on Mar. 4, 2021.
Application No. PCT/US2021/020807 is a continuation-in-part of application No. 16/808,754, filed on Mar. 4, 2020.

(51) Int. Cl. E04F 10/06; E04H 15/08

(52) U.S. Cl. CPC E04F 10/0666; B60P 3/32; E04H 15/08; E04F 10/0614

(57) ABSTRACT

An awning bar includes an awning bar body, the awning bar body having a length extending between a first end and a second end. The awning bar further includes at least one power track extending along the awning bar body. The power track includes at least one magnet configured to provide magnetic attachment to the power track and provide power to an accessory upon contact with the power track. An awning bar kit includes an awning bar and at least one awning bar accessory. An awning bar system includes an awning bar and at least one arm attachable to the awning bar. The arm is configured to move the awning bar away and towards a vertical wall.

### CROSS-REFERENCE TO RELATED APPLICATIONS

This application is a continuation of, and claims priority to and the benefit of International Application No. PCT/US21/20807, filed Mar. 4, 2021, which claims priority to and the benefit of U.S. patent application Ser. No. 16/808,754, filed Mar. 4, 2020. This application is a continuation-in-part of and claims priority to and the benefit of U.S. patent application Ser. No. 16/808,754, filed Mar. 4, 2020. The entire contents of International Application No. PCT/US21/20807 and U.S. patent application Ser. No. 16/808,754 are incorporated by reference.

### TECHNICAL FIELD

The technical field relates to awning bars. Specifically, the technical field relates to a powered awning bar.

### BACKGROUND

Outdoor recreation is often a reason why people use outdoor living spaces or recreational vehicles, commonly referred to as “RV's” such as motor homes and campers. Outdoor living spaces and RV's often have awnings that provide shade and protection from rain and other weather elements when users are spending time outdoors. Concerns during RV and outdoor recreation include adequate lighting, security and privacy, as well as powering accessories needed to fully enjoy an outdoor space and outdoor events, such as lighted décor, speakers, projectors, and ambient lighting. An awning bar configured to power and facilitate use of multiple accessories would be well-received in the art.

### SUMMARY

According to one aspect, an awning bar comprises an awning bar body, the awning bar body having a length extending between a first end and a second end; and at least one power track extending along the awning bar body, wherein the power track includes at least one magnet configured to provide magnetic attachment to the power track and provide power to an accessory upon contact with the power track.

According to one aspect, an awning bar kit comprises an awning bar including an awning bar body, the awning bar body having a length extending between a first end and a second end, and at least one power track extending along the awning bar body, wherein the power track includes at least one magnet configured to provide magnetic attachment to the power track and provide power to an accessory upon contact with the power track, and at least one awning bar accessory configured to magnetically attach to the power track and receive power from the power track.

According to one aspect, an awning bar system includes an awning bar including an awning bar body, the awning bar body having a length extending between a first and second end, and at least one power track extending along the awning bar body, wherein the power track includes at least one magnet configured to provide magnetic attachment to the power track and provide power to an accessory upon contact with the power track, wherein the awning bar is configured to attach to a portion of an awning canopy; and at least one arm attachable to the awning bar, wherein the at least one arm is configured to move the awning bar away from a vertical wall and move the awning bar toward the vertical wall such that in a first awning bar position, the awning bar is extended away from the vertical wall and the canopy is in an open position and extending between the awning bar and vertical wall, and such that in a second awning bar position, the awning bar is retracted to the vertical wall and the canopy is in a closed position.

### BRIEF DESCRIPTION OF DRAWINGS

FIG. 1 depicts a perspective view of a projector system according to one embodiment;

FIG. 2 depicts a cut-off perspective view of an awning bar of a projection system according to one embodiment;

FIG. 3 depicts a cut-off perspective view of an awning bar of a projection system according to one embodiment;

FIG. 4 depicts a cut-off perspective view of an awning bar of a projection system according to one embodiment

FIG. 5 depicts a cut-off perspective view of an awning bar of a projection system according to one embodiment;

FIG. 6 depicts a cut-off perspective view of the awning bar of the projection system of FIG. 4 according to one embodiment;

FIG. 7 depicts a cut-off perspective view of the awning bar of the projection system of FIGS. 4-5 according to one embodiment;

FIG. 8 depicts a cross-sectional view of the projection system of FIG. 1 taken along line A-A according to one embodiment;

FIG. 9 depicts an environmental view of a projector system according to one embodiment;

FIG. 10 depicts a cross-sectional view of an awning bar of a projection system according to one embodiment;

FIG. 11 depicts an environmental view of an awning bar having a power track according to one embodiment;

FIG. 12A is a perspective view of an awning bar having a power track according to one embodiment;

FIG. 12B is a perspective view of an awning bar having a power track according to one embodiment;

FIG. 12C is a perspective view of an awning bar having a power track according to one embodiment;

FIG. 13A is a cross-sectional view of the awning bar of FIG. 12A taken along line 13A-13A;

FIG. 13B is a cross-sectional view of the awning bar of FIG. 12B taken+along line 13B-13B;

FIG. 13C is a cross-sectional view of the awning bar of FIG. 12C taken along line 13C-13C;

FIG. 14 is a cut-off view of an awning bar having accessories attached thereto according to one embodiment;

FIG. 15 is an environmental view of an awning bar with a projector and speakers attached thereto according to one embodiment; and

FIG. 16 is an environmental view of an awning bar with a banner accessory attached thereto according to one embodiment.

### DESCRIPTION

A detailed description of the hereinafter-described embodiments of the disclosed apparatus and method are presented herein by way of exemplification and not limitation with reference made to the Figures. Although certain embodiments are shown and described in detail, it should be understood that various changes and modifications might be made without departing from the scope of the appended claims. The scope of the present disclosure will in no way be limited to the number of constituting components, the materials thereof, the shapes thereof, colors thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

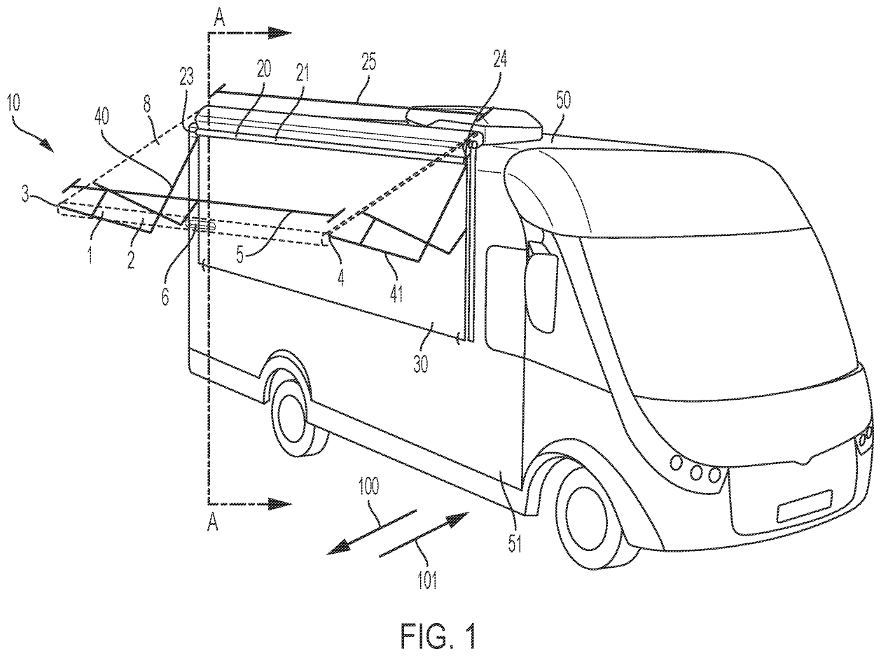

With reference to FIG. 1, a perspective view of a projector system 10 according to one embodiment is shown. The projector system includes an awning bar 1. The awning bar includes an awning bar body 2 that has a first end 3 and a second end 4, and a length 5 extending between the first end 3 and the second end 4. The projector system 10 also includes a projector 6, which has a projection lens 7 (not shown). The projector 6 is attachable to the awning bar 2 along the length 5. The awning bar 1 is configured to attach to a portion of an awning canopy 8 such that the portion of the awning canopy 8 is attachable to the awning bar body 2 along the length such that the projection lens 7 is located below the awning canopy 8 when the awning canopy 8 is in an open position as shown in FIG. 1. The awning canopy 8 and awning bar 1 are shown with dotted lines in FIG. 1 to show the location of these elements and permit other elements such as the projector 6 to be seen “through” the elements shown in dotted lines.

The projector 6 may be attachable to the awning bar 1 by clamps, straps, screws, nails, fasteners, ridges, and the like. The projector 6 may be configured to attached to the awning bar 1 when the awning bar 1 is in a first awning bar position the extended away from the vertical wall 51. The projector 6 may include one or more tabs configured to lay against the awning bar 1 and may further include holes configured to align with matching holes along the length 5 of the awning bar 1 such that the projector 6 may be attached to the awning bar by aligning the holes of the tabs with the holes in the awning bar and screwing screws into the corresponding holes such that the projector 6 is affixed to the awning bar 1. In one embodiment, the awning bar 1 may have a series of equidistant holes along the length 5 of the awning bar body 2 such that the placement of the projector 6 can be customized to one or more locations along the awning bar 1. The projector 6 may be a standard projector, a portable projector, and the like. The projector 6 is not limited to having the shape or dimensions shown in the embodiments in the Figures. For example, the projector 6 may have a cube shape, a cylinder shape, and the like. The projector 6 may be configured to connect with a smart phone, laptop, tablet, or other mobile device and project images or videos from a mobile device. The projector 6 may connect with a mobile device by a wireless connection such as WiFi or Bluetooth®. The projector may connect with a mobile device by physical attachment with the mobile device.

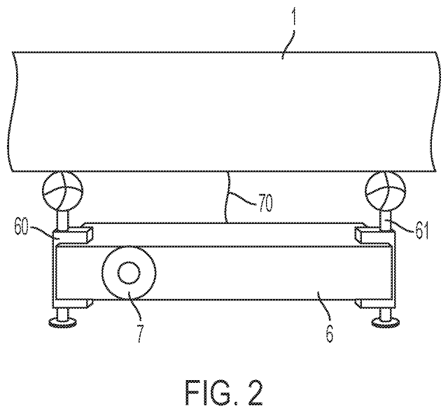

In another embodiment, the projector 6 may be attachable to the awning bar by one or more clamps. For example, with reference to FIG. 2, a cut-off perspective view of an awning bar 1 of a projector system is shown according to one embodiment. The awning bar 1 may include a first clamp 60 and a second clamp 61. The first and second clamps 60, 61, may be adjustable such that any dimension projector 6 could be held by the first and second clamps 60, 61. The first and second clamps 60, 61 may be adjustable in position along the length 5 of the awning bar 1, such as by a track extending along the length 5. The first and second clamps 60, 61 may be securably adjusted to various distances away from one another to accommodate differently sized projectors. The first and second clamps 60, 61 may each include a ball and socket joint to allow securable adjustment of the position of the projector 6, for example, to adjust the angle of projection through the projector lens 7. The projector 6 is not limited to being attached to the awning bar by a first and a second clamp 60, 61, and may be attached to the awning bar by a single clamp. The projector 6 may be attached by more than two clamps.

In another embodiment, the projector 6 may be attachable to the awning bar 1 by a single clamp or more than two clamps. Wiring 70 used for operation of the projector 6 may be configured to insert into the awning bar 1, and may connect or interface with existing wiring within the awning bar 1, such as wiring for a motor used for automatic extension and retracting of the awning bar 1. The projector 6 is not limited to powering by wiring 70, for example, the projector 6 may be configured to interface with a power supply provided by electrical components of the awning bar 1 such as a power track. For example, the awning bar 1 may include a power track along the length 5. The awning bar 1 may include a power strip. The projector 6 may be battery operated. The projector 6 may be rechargeable, such as by charging, such as by a pluggable charger, by wireless charging, by manual charging such as by a hand crank, by solar power, and the like. The projector 6 may be powered by a lead cord plugged into an outside wall, inside wall, outside of a recreational vehicle, inside of a recreational vehicle, a generator, and the like.

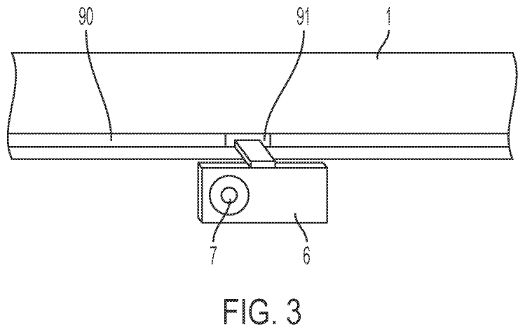

With reference to FIG. 3, in another embodiment, the projector 6 may be attachable to the awning bar 1 by being insertable into a ridge of the awning bar 1. FIG. 3 shows a cut-off perspective view of an awning bar 1 of a projector system according to one embodiment. The awning bar 1 includes a ridge 90 extending along the length 5 of the awning bar, and the projector 6 includes a protrusion 91 extending from the projector 6 that is configured to be inserted into the ridge 90. For example, the protrusion may be a bar, flange, lip, a knob, a projection, and the like. As an example, the projector 6 may include a rotatable protrusion 91 that is configured to be inserted into the ridge 90 and then be rotated such that the protrusion 91 is securably arranged within the ridge 90. For example the protrusion 91 may have a width equal to or less than a width of an opening of the ridge 90, and the ridge 90 may comprise an inner portion within the awning bar 1 that accommodates the protrusion 91 when the protrusion 91 is rotated 90 degrees, such that the protrusion 90 is secured within the inner portion of the ridge 90 within the awning bar. The ridge 90 may be a track, a lipped opening, and the like. The ridge 90 may include a power track configured to supply power to the projector 6 when the protrusion 91 is inserted into the ridge 90. For example, power may be supplied to the projector upon contact of the protrusion 91 with the ridge 90.

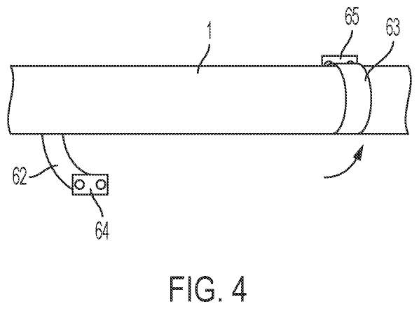

In yet another embodiment, the projector 6 may be attachable to the awning bar 1 by one or more moveable brackets. With reference to FIG. 4, a cut-off perspective view of an awning bar 1 of a projector system is shown according to one embodiment. The awning bar 1 in this embodiment includes a first moveable bracket 62 and a second moveable bracket 63. The first and second moveable brackets 62, 63 are hingedly moveable to be extended downward from the awning bar 1 as shown with respect to the first moveable bracket 62, or extended upward to the awning bar 1 as shown with respect to the second moveable bracket 63 such that the first and second moveable brackets can be secured against and confirm to the surface of the awning bar 1 when not in use. In this way, the canopy 8 can be rolled up around the awning bar 1 without being obstructed by the first and second moveable brackets. The first and second moveable brackets 62, 63 may each include a tab 64, 65 having one or more holes configured to align with holes in the outer surface of a projector 6, such that the first and second moveable brackets 62, 63 may be secured to the projector 6 such as by screws, bolts, and the like. In another embodiment, the tabs 64, 65 may be configured to insert into corresponding ridges on the projector 6, such as on the back of the projector 6. The projector 6 may be configured to attach to the awning bar 1 by more than one type of attachment interface, such as by clamps 60, 61, brackets 62, 63, and by a ridge 90 in the awning bar 1.

The projector 6 may be attachable to the awning bar 1 by being inserted into the awning bar. With reference to FIGS. 4, 5, and 6, a cut-off perspective view of an awning bar of a projection system according to embodiments is shown. The awning bar 1 may be a tube, such as a roller tube, hollow tube, hollow cylinder and the like having an opening 9 that extends between the first end 3 and the second end 4, and the projector 6 is attachable to the awning bar 1 within the opening 9, such as by inserting the projector 6 into the opening 9 as shown in FIG. 6. The opening 9 may include a compartment configured to contain the projector 6 such that the projector 6 is secured in position within the awning bar 1 opening 9 and cannot move left or right within the opening 9. In another embodiment, the opening 9 may include one or more tabs, stops, barriers, ridges, walls, protrusions and the like configured to contain the projector 6 to a secured position within the opening 9. Wiring 70, such as a power cord, used for the operation of the projector 6 may be fed through the opening 9 to the projector 6.

The opening 9 may be cylindrical in shape and may include a flat platform on which the projector 6 may be arranged. In this embodiment, the flat platform may include an adhesive such as hook and loop fasteners, or slide-reducing material such as rubber or silicon to attach the projector 6 or prevent the projector 6 from moving on the flat platform.

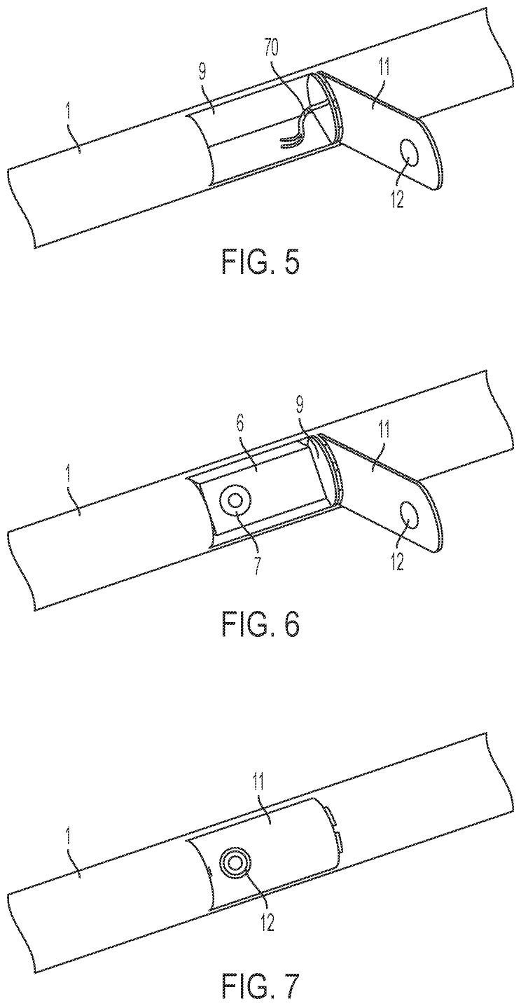

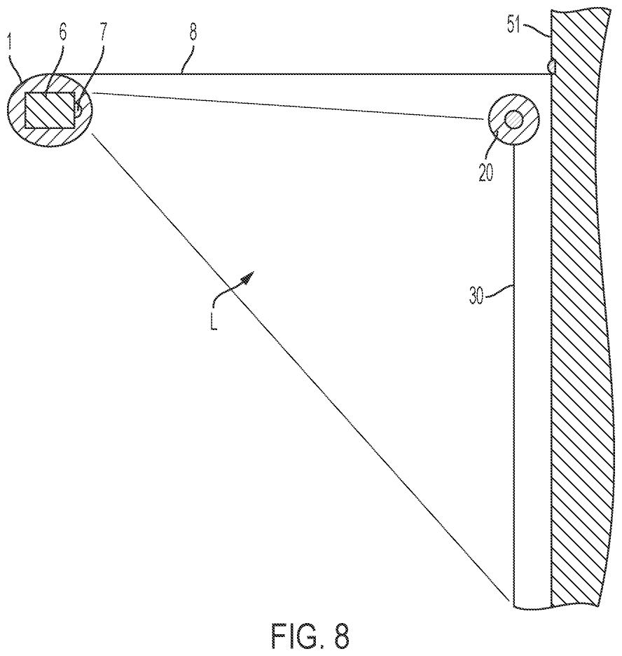

The awning bar 1 may include a door 11 that can be opened, as shown in FIGS. 5 and 6, to place a projector 6 within the opening 9 and closable to contain the projector 6 within the opening 9, as shown in FIG. 8. The door 11 may be openable and closable such as by hinges, or by sliding back and forth or up and down, for example, on one or more tracks. The door 11 may comprise a portion of the surface of the awning bar body 2. The opening 9 may include a waterproof or moisture proof casing configured to contain the projector 6 and prevent moisture from contacting the projector 6 such that moist environments do not interfere with the operation of the projector 6. The door 11 may include a hole 12 configured to align with the projector lens 7 when the door 11 is in a closed position such that the projector 6 is able to project light through the hold 12. The hole 12 may include a transparent plastic, glass, or other material that is waterproof or moisture proof. The hole 12 may include a scratch-proof material, a smudge-proof material, and the like.

With continuing reference to FIG. 1, the awning bar 1 is extendable away from a vertical wall 51, such as an outside wall of a recreational vehicle 50. The vertical wall 51 is not limited to being an outer wall of a recreational vehicle 50, and may be a wall of a building such as a house, shed, garage, trailer, and the like. The vertical wall 51 may be a fence such as a landscaping fence. Recreational vehicle 50 may be a motorhome, a camper, a hauler, a travel trailer, a teardrop camper, a pop-up camper, and the like.

The awning bar 1 is extendable such that in a first position, shown in FIG. 1, the awning bar 1 is extended away from the vertical wall 51 and the canopy 8 is in an open position, and in a second position, the awning bar 1 is retracted to the vertical wall 51 and the canopy 8 is in a closed position. The projector 6 is attachable to the awning bar 1 such that in the first position, the projector 6 is configured to project light towards and onto the vertical wall 51. The awning bar 1 may be configured to extend in direction 100 to the first position, and retract in direction 101 to the second position. In this embodiment, the projector system 10 is attachable to a recreational vehicle 50 on an outer wall 51 of the recreational vehicle 50. The projector system may be attached to an outer wall by screws, bolts, fasteners, nails, rails, and the like. In this embodiment, the awning bar 1 is made of a rigid material, and may be made of metal, plastic, composite material, and the like.

The awning bar 1 may be extendable and retractable by manually pulling the awning bar, such as by a tab, cord, string, handle, and the like in direction 100. In a manual configuration, the awning bar 1 may be retractable in direction 101 by a spring arranged within the awning bar, a manually operable drive head located at the first end 3 or second end 4, and the like. The awning bar 1 may be extendable and retractable by a motor, such as a powered motor located in a drive head at the first end 3 or second end 4. In this embodiment, power may be drawn from a building or recreational vehicle to power the automatic extension and retraction of the awning bar. For example, wiring to power an automatic retractable awning bar may extend from the recreational vehicle to the awning bar 1, and a control panel may be located on the recreational vehicle 50, such as inside the recreational vehicle 50 on an interior wall, or on an outside wall such as vertical wall 51. Wiring may be arranged within a drive head motor casing, and extend along or within at least one moveable arm configured to extend and retract the awning bar 1 from a first awning bar position to a second awning bar position. For example, the projector system may include a first moveable arm 40 and a second moveable arm 41 that are configured to extend and retract the awning bar 1 away from and towards the vertical wall 51. In some embodiments, the projector system 10 may include a single moveable arm, such as one of the first moveable arm 40 and the second moveable arm 41. The projector 6 may be configured to connect or interface with wiring 70 of an automatic or powered awning bar 1. In another embodiment, any wiring 70 of the projector 6 may be configured to be arranged along the length 5 of the awning bar 1 for example, along the outside of the awning bar 1, or within the awning bar 1. Wiring 70 of the projector 6 may also extend along or within at least one movable arm, to the recreational vehicle 50 or other power source. For example, wiring 70 of the projector 6 may be arranged along the length 5 of the awning bar 1 and along or within at least one movable arm such that the wiring 70 is not visibly hanging or protruding from the awning bar 1, at least one movable arm, and the recreational vehicle 50 or other power source.

In an embodiment, the projector system 10 may include a retractable awning assembly that comprises the first awning bar 1 and at least one arm, such as the first moveable arm 40 and second moveable arm 41. The retractable awning assembly may include the canopy 8. The canopy 8 and first and second moveable arms 40, 41 are attachable to the vertical wall 51, such as by screw, nail, clamp, hook, hole, bore, and the like. The canopy 8 may be attachable to the vertical wall 51 by a rail including a ridge, and the canopy 8 may include a cord configured to be slid into the ridge such that the canopy 8 is secured to the rail. The canopy 8 may be attachable to the awning bar 1 by a ridge along the length 5 of the awning bar 1. For example, the canopy may have a second cord configured to be slid into the ridge of the awning bar 1 such that the canopy 8 is attached to the awning bar 1. In yet another embodiment, the projector system may include a recreational vehicle 50 having a vertical outer wall such as vertical wall 51.

In this embodiment, in the second awning bar position, the canopy 8 may be rolled around the awning bar 1. As the awning bar 1 extends away from the vertical wall 51 in direction 100, the awning bar 1 is configured to rotate such that the canopy 8 unrolls to an open position, in the first awning bar position. The awning bar 1 may rotate by a spring, drive head, motor, and the like. As the awning bar 1 retracts towards the vertical wall 51, the awning bar 1 may rotate in the opposite direction such that the canopy 8 rolls around the awning bar 1. For example, the awning bar 1 may be a tube such as a roller tube, a hollow tube, a hollow cylinder, and the like. The projector 6 and awning bar 1 may be configured such that the projector 6 rotates within an opening 9 of the awning bar 1 as the awning bar 1 rotates during extension and retraction of the awning bar 1 in direction 100 and direction 101. The projector 6 may be arranged in the opening 9 of the awning bar 1 such that when the awning bar 1 is fully extended the projector 6 is positioned within the awning bar 1 opening 9 such that the projector 6 is positioned such that light projected from the projector 6 is projected onto a projector screen 30 or vertical wall 51.

Referring back to FIG. 1, in an embodiment, the projector system includes a second awning bar 20 including a second awning bar body 21 having a first end 23 and a second end 24, and a length 25 extending between the first end 23 and the second end 24. The second awning bar 20 includes a projector screen 30. The projector screen 30 is attachable to the second awning bar 20 along the length 25 of the second awning bar 20. For example, the projector screen 30 may include a cord along an end of the projector screen that is configured to slide into a ridge along the length 25 of the second awning bar body 21. The second awning bar 20 may be rotatable such that in a first projector screen position, the projector screen 30 is unrolled and the projector screen 30 extends from the second awning bar 20 along a portion of the vertical wall 51 such that the projector 6 is configured to project light onto the projector screen 30 when the awning bar 1 is in the first awning bar position, and wherein in a second projector screen position of the projector screen, the projector screen 30 is rolled around the second awning bar 20. The awning bar 1 and second awning bar 20 may be controllable independently of one another such that the awning bar 1 is moveable when the projector screen 30 is extended and when the projector screen 30 is not extended. One or more of the vertical wall 51 and projector screen may include hooks, connectors, magnets, fasteners, and the like configured to secure to the end of the projector screen 30 to the vertical wall 51 such that the projector screen 30 is securable in the first projector screen position along the vertical wall 51. In another embodiment, the bottom corners of the projector screen 30 may each include a weight or weighted material such that the projector screen 30 hangs down smoothly when in the first projector screen position, extended along the vertical wall 51. In another embodiment, the projector system 10 may not include a projector screen 30 or second awning bar 20. For example, the projector system 10 may be configured such that the projector 6 projects light directly onto the vertical wall 51. The second awning bar 20 may be automatically moved by a control panel, such as a control panel that also controls the awning bar 1.

With reference to FIG. 8, a cross-sectional view of the projector system of FIG. 1 is shown taken along line A-A. When the awning bar 1 is in a first awning bar position, the projector 6 is configured to project light L onto the projector screen 30. The canopy 8 is in an open position, and the projector 6 is arranged below the canopy 8. The canopy 8 shields sunlight, moonlight, light pollution, and other extraneous light, as well as rain, snow, sleet, and other weather elements from interfering with light L projected by the projector 6.

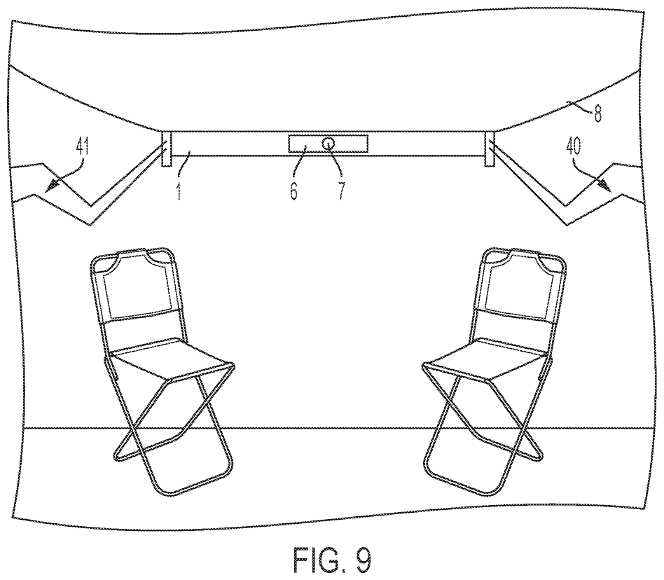

With reference to FIG. 9, an environmental view of the projector system is shown according to one embodiment. In this embodiment, the awning bar 1 is in an extended position, and the projector 6 is located within an opening 9 of the awning bar 1. By orienting themselves towards the vertical wall 51 (not shown), one or more users can view images, film, and the like projected onto the projector screen 30 or vertical wall 51 by the projector 6.

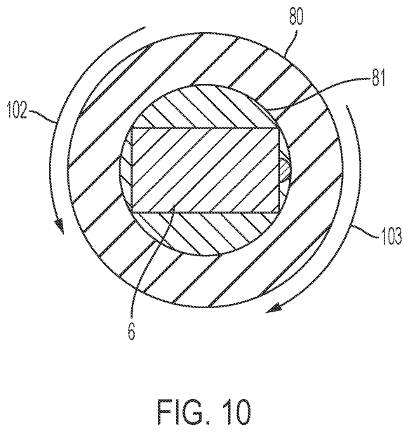

With reference to FIG. 10, a cross-sectional view of an awning bar 1 of a projection system 10 according to one embodiment. In this embodiment, the awning bar 1 includes an outer cylinder 80 and an inner cylinder 81 positioned within the outer cylinder. The projector 6 is securably positionable within the inner cylinder, for example, within an opening of the inner cylinder, within a compartment located within the inner cylinder, and the like. The inner cylinder is attachable to at least one movable arm configured to extend the awning bar 1 and retract the awning bar 1, such as first and second movable arm 40, 41. For example, the inner cylinder 81 may be attached to an end of the at least one movable arm such that the inner cylinder is stationary in relation to the end of the movable arm. The outer cylinder 80 is rotatable around the inner cylinder, and may be rotated in direction 102 when the awning bar 1 is being retracted and the canopy 8 is being rolled around the awning bar 1, and may be rotated in direction 103 when the awning bar 1 is being extended and the canopy 8 is unrolling about the awning bar 1 to an open position. In this embodiment, the stationary inner cylinder limits the rotation of the projector 6 during extension and retraction of the awning bar 1. The projector 6 may be configured to operate in a position in which the projecting direction of the projector 6 is parallel with the ground, or within a certain angle of being parallel with the ground, such as −10° to 10°, −45° to 45°, −90 to 90°, or less than −10° or more than 90°. The inner cylinder 81 may be configured to limit the rotation of the projector 6 within the operable angle range of the projector 6. The inner cylinder may be configured to limit the rotation of the projector 6 to less than 180° of rotation, or less than 360° of rotation in relation to the ground. This may preserve the internal components of the projector 6 and increase the longevity of the projector 6 over multiple extensions and retractions of the awning bar 1.

In another embodiment, the awning bar 1 may include speakers. For example, the first end 3 and the second end 4 of the awning bar 1 may include speakers. As an example, speakers may be attached to one or more of the first end and second end. The speakers may be connectable to the projector 6, such as by wiring or Bluetooth® or other wireless connection.

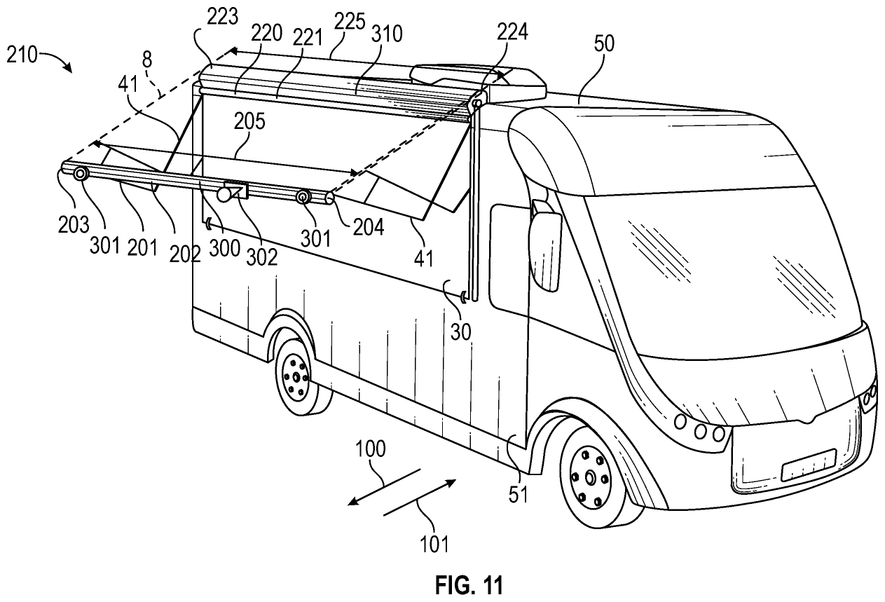

With reference to FIG. 11, an environmental view of an awning bar 201 and awning bar system 210 is shown according to one embodiment. The awning bar 201 includes an awning bar body 202 that has a first end 203 and a second end 204, and a length 205 extending between the first end 203 and the second end 204. The awning bar 201 includes a power track 300 extending along the awning bar body 202. The power track 300 includes at least one magnet configured to provide power. For example, in an embodiment, the power track 300 is configured such that power is supplied to an accessory upon contact with the power track 300. For example, the power track 300 may be configured to provide a 12V power supply. The power track 300 may be a magnetic strip. The power track 300 is configured to magnetically attach and provide power to accessories. Accessories may be any type of mobile device, electronic device, light, and the like. As an example, as shown in FIG. 11, a plurality of security cameras 301 may be magnetically attached to and powered by the power track 300, permitting users of RV 50 to enhance the security of their outdoor living space. As another example, lighting such as light fixture 302 may be magnetically attached to and powered by the power track 300. Accessories attachable and powerable by the power track are not limited to security cameras and lighting, and can further include any powered device, electronic device and the like, such as speakers; motion sensors; lighted banners; projectors, such as projector 6; charging docks for mobile devices such as cell phones, smart phones, cameras, and batteries, and other electronic devices; mobile hot spot devices; antenna, and the like. A light accessory is not limited to a light fixture 302 as shown in the Figures, and could be an LED light bulb, incandescent light bulb, mini light, and the like.

With continuing reference to FIG. 11, the awning bar 201 is configured to attach to a portion of an awning canopy, such as awning canopy 8, such that the portion of the awning canopy 8 is attachable to the awning bar body 202 along the length and such that the power track 300 is located below the awning canopy 8 when the awning canopy 8 is in an open position as shown in FIG. 11. The awning bar 201 may be configured such that when the canopy 8 is fully extended, the power track 300 is positioned facing out and away from the canopy 8 as shown in FIG. 11. In another embodiment, the awning bar may be configured such that when the canopy is fully extended, the power track 300 is positioned facing in towards, for example, an RV 50. In yet another embodiment, the awning bar 201 may include a first power track 300 and a second power track arranged opposite one another along the length 205 of the awning bar 201 such that when the canopy 8 is fully extended, the first power track 300 is positioned facing out and away from the canopy 8, and the second power track is arranged positioned facing in and towards, for example, the RV. Accessories such as security cameras 301, and light fixture 302 are attachable to the first power track 300 and the second power track. The awning canopy 8 is shown with dotted lines in FIG. 11 to show the location of these elements and permit other elements to be seen “through” the elements shown in dotted lines.

In one embodiment, an awning bar kit may comprise an awning bar, such as awning bar 201 including an awning bar body, such as awning bar body 202, the awning bar body having a length, such as length 205, extending between a first end and a second end, such as first end 203 and second end 204 and at least one power track, such as power track 300 extending along the awning bar body, wherein the power track includes at least one magnet configured to provide power; and at least one awning bar accessory, such as security cameras 301, or lighting fixture 302, or other accessory, configured to magnetically attach to the power track and receive power from the power track 300.

With continuing reference to FIG. 11, the awning bar 201 is extendable away from a vertical wall 51, such as an outside wall of RV 50. The vertical wall 51 is not limited to being an outer wall of a recreational vehicle 50, and may be a wall of a building such as a house, shed, garage, trailer, and the like. The vertical wall 51 may be a fence such as a landscaping fence. Recreational vehicle 50 may be a motorhome, a camper, a hauler, a travel trailer, a teardrop camper, a pop-up camper, and the like.

The awning bar 201 is extendable such that in a first position, shown in FIG. 11, the awning bar 201 is extended away from the vertical wall 51 and the canopy 8 is in an open position, and in a second position, the awning bar 201 is retracted to the vertical wall 51 and the canopy 8 is in a closed position. The awning bar 201 may be configured to extend in direction 100 to the first position, and retract in direction 101 to the second position. In this embodiment, the awning bar system 210 is attachable to a recreational vehicle 50 on an outer wall 51 of the recreational vehicle 50. The awning bar system 210 may be attached to an outer wall by screws, bolts, fasteners, nails, rails, and the like. In this embodiment, the awning bar 201 is made of a rigid material, and may be made of metal, plastic, composite material, and the like.

The awning bar 201 may be extendable and retractable by manually pulling the awning bar 201, such as by a tab, cord, string, handle, and the like in direction 100. In a manual configuration, the awning bar 201 may be retractable in direction 101 by a spring arranged within the awning bar, a manually operable drive head located at the first end 203 or second end 204, and the like. The awning bar 201 may be extendable and retractable by a motor, such as a powered motor located in a drive head at the first end 203 or second end 204. In this embodiment, power may be drawn from a building or recreational vehicle to power the automatic extension and retraction of the awning bar. For example, wiring to power an automatic retractable awning bar may extend from the recreational vehicle to the awning bar 201, and a control panel may be located on the recreational vehicle 50, such as inside the recreational vehicle 50 on an interior wall, or on an outside wall such as vertical wall 51. Wiring may be arranged within a drive head motor casing, and extend along or within at least one moveable arm configured to extend and retract the awning bar 201 from a first awning bar position to a second awning bar position. For example, the awning bar system 210 may include a first moveable arm 40 and a second moveable arm 41 that are configured to extend and retract the awning bar 201 away from and towards the vertical wall 51. In some embodiments, the awning bar system may include a single moveable arm, such as one of the first moveable arm 40 and the second moveable arm 41.

In another embodiment, an awning bar system, such as awning bar system 210 may comprise an awning bar such as awning bar 201 including an awning bar body, such as awning bar body 202, the awning bar body having a length, such as length 205, extending between a first and second end, such as first end 203 and second end 204, and at least one power track, such as power track 300 extending along the awning bar body, wherein the power track includes at least one magnet configured to provide power, wherein the awning bar is configured to attach to a portion of an awning canopy, such as awning canopy 8; and at least one arm attachable to the awning bar, such as arm 40 or arm 41, the at least one arm configured to move the awning bar away from a vertical wall and move the awning bar toward the vertical wall such that in a first awning bar position, the awning bar is extended away from the vertical wall and the canopy is in an open position and extending between the awning bar and vertical wall, and such that in a second awning bar position, the awning bar is retracted to the vertical wall and the canopy is in a closed position.

In an embodiment, the awning bar system 210 includes a second awning bar 220 having a second awning bar body 221 having a first end 223 and a second end 224, and a length 225 extending between the first end 223 and the second end 224. The second awning bar 220 includes a power track 310 that includes at least one magnet. The power track 310 may be a magnetic strip. The power track 310 is configured to magnetically attach and provide power to accessories such as security cameras 301 and light fixture 302. Accessories magnetically attachable and powerable by the power track 310 are not limited to security cameras and lighting, and can further include any powered device, such as speakers; motion sensors; lighted banners; projectors, such as projector 6; charging docks for mobile devices such as cell phones, smart phones, cameras, and batteries, and other electronic devices; mobile hot spot devices; antenna, and the like.

In one embodiment, the second awning bar 220 may include a projector screen 30. The projector screen 30 is attachable to the second awning bar 220 along the length 225 of the second awning bar 220. For example, the projector screen 30 may include a cord along an end of the projector screen that is configured to slide into a ridge along the length 225 of the second awning bar body 221. The second awning bar 220 may be rotatable such that in a first projector screen position, the projector screen 30 is unrolled and the projector screen 30 extends from the second awning bar 220 along a portion of the vertical wall 51 such that a projector accessory magnetically attached to power track 300, such as projector 6 is configured to project light onto the projector screen 30 when the awning bar 201 is in the first awning bar position, and wherein in a second projector screen position of the projector screen, the projector screen 30 is rolled around the second awning bar 220. The awning bar 201 and second awning bar 220 may be controllable independently of one another. For example, the awning bar 201 and second awning bar 220 may be controllable independently of one another such that the awning bar 201 is moveable when the projector screen 30 is extended and when the projector screen 30 is not extended.

One or more of the vertical wall 51 and projector screen may include hooks, connectors, magnets, fasteners, and the like configured to secure to the end of the projector screen 30 to the vertical wall 51 such that the projector screen 30 is securable in the first projector screen position along the vertical wall 51. In another embodiment, the bottom corners of the projector screen 30 may each include a weight or weighted material such that the projector screen 30 hangs down smoothly when in the first projector screen position, extended along the vertical wall 51. In another embodiment, the awning bar system 210 may be configured such that a projector accessory such as projector 6 projects light directly onto the vertical wall 51. The second awning bar 220 may be automatically moved by a control panel, such as a control panel that also controls the awning bar 201.

In an embodiment, an awning bar system 210 may include a second awning bar, such as second awning bar 220 including a second awning bar body, the second awning bar body having a length, such as length 225 extending between a third end, such as end 223 and fourth end, such as end 224, and a second power track, such as second power track 310 extending along the second awning bar body, wherein the second power track includes a second magnet configured to provide power, wherein the second awning bar is configured to attach to the vertical wall.

The power track 300 may be configured to be battery operated. For example, one of the awning bar 201 and the power track 300 may include a rechargeable battery. The rechargeable battery may be recharged by pluggable charger, wireless charging, manual charging such as by a hand crank, by solar power, and the like. In one embodiment, the awning bar 201 may be powered by a lead cord plugged into an outside wall, outside of a recreational vehicle, a generator, and the like. In an embodiment, wiring delivering power to the power track 300 may be hidden at least partially within the awning bar body 202 and within or along an arm such as first arm 40 or second arm 41 of an awning bar system such as awning bar system 210.

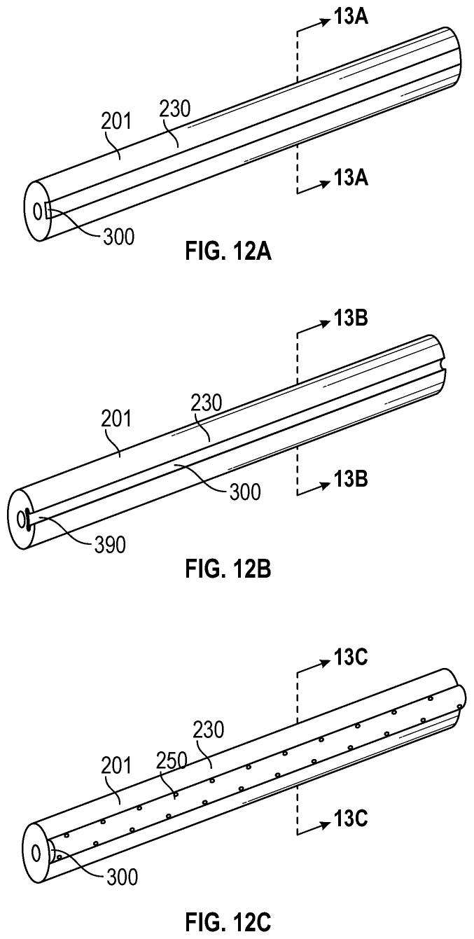

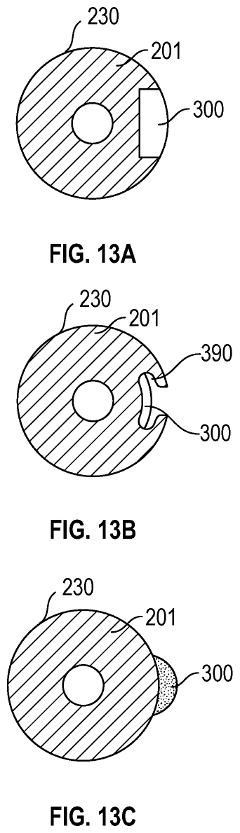

Referring now to FIG. 12A, a perspective view of an awning bar 210 according to one embodiment is shown. In this embodiment, the power track 300 is recessed into the awning bar body 202 such that the power track 300 is flush with a surface 230 of the awning bar body 202, as shown in FIG. 13A, a cross-sectional view of the awning bar 210 of FIG. 12A taken along line 13A-13A. In this embodiment, the power track 300 may include a magnet. For example, the power track 300 may be a magnetic strip configured to provide attachment and power to accessories.

With reference to FIG. 12B, a perspective view of an awning bar 210 according to another embodiment is shown. In this embodiment, the awning bar 201 includes a ridge 390 extending along the length 5 of the awning bar 201. The power track 300 is positioned within the ridge 390, as shown in FIG. 13B, a cross-sectional view of the awning bar 201 of FIG. 12B taken along line 13B-13B. The ridge 390 may be configured to receive a protrusion extending from an accessory, such as protrusion 91 extending from projector 6, configured to be inserted into the ridge 90 and magnetically attach with power track 300 to provide power to the accessory. For example, the protrusion may be a bar, flange, lip, a knob, a projection, and the like. As an example, an accessory may include a magnetic rotatable protrusion 91 that is configured to be inserted into the ridge 390 and then be rotated such that the protrusion 91 is securably arranged within the ridge 390 and magnetically attached to the power track 300 such that power is supplied to the accessory upon contact of the protrusion 91 with the ridge 90. For example the protrusion 91 may have a width equal to or less than a width of an opening of the ridge 390, and the ridge 390 may comprise an inner portion within the awning bar 201 that accommodates the protrusion 91 when the protrusion 91 is rotated 90 degrees, such that the protrusion 91 is secured within the inner portion of the ridge 90 within the awning bar. The ridge 390 may be a track, a lipped opening, and the like. As an example, the ridge 390 may include a first flange extending along the length of the awning bar 201 and a second flange extending along the length of the awning bar facing the first flange.

With reference to FIG. 12C, in another embodiment, the power track 300 may be attached to the surface 230 of the awning bar 201 such that the power track 300 protrudes from the surface 230 of the awning bar, as shown for example in FIG. 13C, a cross-sectional view of the awning bar 201 shown in FIG. 12C taken along line 13C-13C. In this embodiment, the power track 300 may include a curved surface such that accessories may be attached thereto positioned at different angles, for example, light fixtures attached and powered by the power track 300 may be pointed in various angles by attaching the light fixtures along different areas of the power track 300 curved surface. The power track 300 is not limited to having a curved surface and may have a flat surface, a plurality of flat surfaces, and the like. The power track 300 may be attached to the awning bar body by rivets, such as rivets 250, screws, adhesive, welding, and the like. The power track 300 may be attached to the awning bar body by being inserted into a ridge along the awning bar body configured to receive a corresponding protrusion along the power track 300.

The power track 300 may be removeable and interchangeable. For example, in one embodiment, the awning bar 201 may include a ridge such as ridge 390, which may interface with different configurations of the power track 300, for example, a power track 300 may be shaped to slide into the ridge and be flush with the surface 230 of the awning bar 201, for example, flush as shown in the embodiment in FIG. 12A. In another embodiment the power track 300 may be shaped to slide into the ridge to be positioned within the ridge, for example, as shown in the embodiment in FIG. 12B. In another embodiment, the power track 300 may have a protrusion along the length of the power track configured to slide into the ridge, and a curved surface or other shaped surface configured to protrude from the surface 230 of the awning bar, for example, as shown in the embodiment in FIG. 12C.

In another embodiment, an awning bar system, such as awning bar system 210 shown in FIG. 11, may include the awning bar 201 and second awning bar 220, which may each have a power track 300/310 that is flush with the surface 230, within a ridge 340 along the length of the awning bar 201/220, or attached to the surface 230 such that the power track 300/310 protrudes from the surface 230.

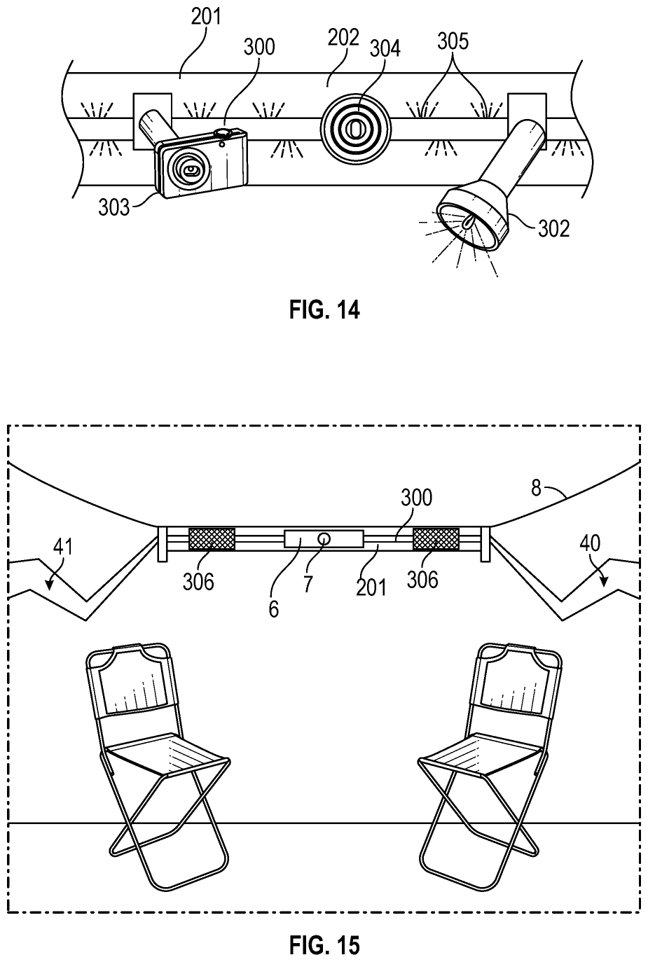

Referring now to FIG. 14, a cut-off view of an awning bar 201 is shown according to one embodiment. The power track 300 may be configured to power one or more accessories at the same time. For example, a user may attach a camera 303, light fixture 302, and motion sensor 304 to the power track 300 at the same time. In one embodiment, an awning bar kit may include the awning bar 201, and one or more accessories. Camera accessories magnetically attachable and powerable to and by the power track 300 are not limited to the camera 303 as depicted in the Figures, and could be any size, dimension, type of camera, such as a hidden camera, a digital camera, a security camera, and the like. Motion sensor accessories magnetically attachable and powerable to and by the power track 300 are not limited to the motion sensor 304 as depicted in the Figures and could be any size, dimension, and type motion sensors. A kit may also include complimentary accessories, such as for security, entertainment, ambiance, and the like. For example, a user may attach a plurality of security cameras, a plurality of motion sensors, and motion-activated lights to the power track 300 as a security system for an outdoor living space, recreational vehicle outdoor living space, and the like. The security cameras, motion sensors, and lighting may be linked via the internet to an application downloadable to a user's mobile device to enable the user to track movement in the vicinity of their outdoor living space. As another example, a user may attach a plurality of lights to the power track 300 in order to illuminate an outdoor living space or recreational vehicle outdoor space for dining and other activities. Lighting accessories may be configured to be controlled via the internet by a corresponding application on a user's mobile device. An yet another example, an accessory may be ambient lighting such as dim incandescent or LED lighting attachable and powerable to and by the power track. In an embodiment, recessed lighting 305 may be integrated into the awning bar 201, and powered by the power track. The brightness of the recessed lighting 305 may be adjustable, such as by a Bluetooth or WiFi remote control.

With reference to FIG. 15, an environmental view of an awning bar 201 is shown. In this embodiment, the canopy 8 of an awning bar system such as awning bar system 210 is in an extended position, and the power track 300 has speakers 306 and a projector 6 magnetically attached thereto such that the power track 300 is providing power to the speakers 306 and projector 6.

The awning bar 201 may include accessory attachment hardware, features, structures, and the like to assist in supporting accessories magnetically attached to the power track 300. Accessory attachment features may include clamps, straps, screws, fasteners, hole and protrusion attachments.

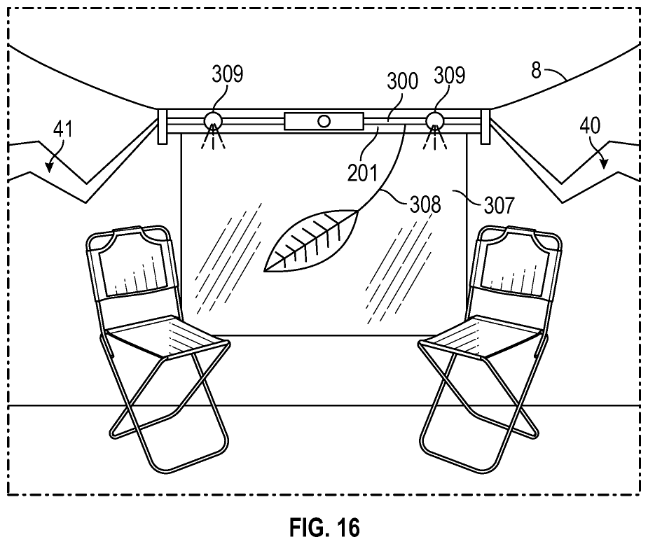

The awning bar 201, as well as second awning bar 220 may also be used to hang tailgating banners and other decorations. With reference to FIG. 16, an environmental view of the awning bar 201 is shown according to one embodiment. A lighted banner 307 is shown hanging from the awning bar 201. Lighting accessories 309 are magnetically attached to and powered by the power track 300 and are positioned to illuminate the lighted banner 307. The lighted banner may also include a lighted design which may be illuminated and powered by the power track 300. The lighted design may have a power cord element 308 configured to attach to the power track 300. In another embodiment, the banner 307 may be magnetically attached directly to the power track 300 of the awning bar 201. In one embodiment, the awning bar 201 may be configured to attach to a tailgate of a vehicle such as a recreational vehicle, a truck, and the like with a banner attached thereto illuminated by lights powered by the power track 300.

The accessories 301, 302, 303, 304, 305, 306, 307, 309 are not limited to having the size and dimensions of the accessories shown in the figures, and could be any size, dimension, and type.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An awning bar comprising:
an awning bar body, the awning bar body having a length extending between a first end and a second end; and
at least one power track extending along the awning bar body, wherein the power track includes at least one magnet configured to provide magnetic attachment to the power track and provide power to an accessory upon contact with the power track.

2. The awning bar of claim 1, wherein the at least one magnet extends from the first end to the second end.

3. The awning bar of claim 1, wherein the awning bar body has a circular cross-section along the length, and wherein the power track is flush with a surface of the awning bar body.

4. The awning bar of claim 1, wherein the awning bar body includes a ridge extending along the length, wherein the power track is located within the ridge of the awning bar body.

5. The awning bar of claim 4, wherein the ridge includes a first flange extending along the length and a second flange extending along the length, wherein a first end of the first flange faces a second end of the second flange.

6. The awning bar of claim 2, wherein the power track is attached to the awning bar body such that the power track protrudes from a surface of the awning bar body along the length.

7. The awning bar of claim 6, wherein the power track is riveted to the surface.

8. The awning bar of claim 1, including a second power track extending along the awning bar body, wherein the second power track includes a second at least one magnet configured to provide magnetic attachment to the second power track and to provide power to an accessory upon contact with the second power track.

9. The awning bar of claim 8, wherein the second power track is located opposite the power track along the awning bar body.

10. The awning bar of claim 8, wherein the power track is at least one of flush with a surface of the awning bar body, located in a ridge along the length, and attached to the surface such that the power track protrudes from the surface, wherein the second power track is at least one of flush with the surface, located in a second ridge along the length, and attached to the surface such that the second power track protrudes from the surface.

11. The awning bar of claim 1, wherein the awning bar is configured to attach to a portion of an awning canopy such that the power strip is located below the awning canopy when the awning canopy is in an open position.

12. The awning bar of claim 1, wherein the power track is a magnetic strip.

13. The awning bar of claim 1, wherein the power track outputs at least 12V.

14. An awning bar kit comprising:
an awning bar including an awning bar body, the awning bar body having a length extending between a first end and a second end, and at least one power track extending along the awning bar body, wherein the power track includes at least one magnet configured to provide magnetic attachment to the power track and provide power to an accessory upon contact with the power track; and
at least one awning bar accessory configured to magnetically attach to the power track and receive power from the power track.

15. An awning bar system including:
an awning bar including an awning bar body, the awning bar body having a length extending between a first and second end, and at least one power track extending along the awning bar body, wherein the power track includes at least one magnet configured to provide magnetic attachment to the power track and provide power to an accessory upon contact with the power track, wherein the awning bar is configured to attach to a portion of an awning canopy; and
at least one arm attachable to the awning bar, wherein the at least one arm is configured to move the awning bar away from a vertical wall and move the awning bar toward the vertical wall such that in a first awning bar position, the awning bar is extended away from the vertical wall and the canopy is in an open position and extending between the awning bar and vertical wall, and such that in a second awning bar position, the awning bar is retracted to the vertical wall and the canopy is in a closed position.

16. The awning bar system of claim 15, further comprising a second awning bar including a second awning bar body, the second awning bar body having a length extending between a third end and fourth end, and a second power track extending along the second awning bar body, wherein the second power track includes a second at least one magnet configured to provide magnetic attachment to the second power track and provide power to an accessory upon contact with the second power track, wherein the second awning bar is configured to attach to the vertical wall.

17. The awning bar system of claim 15, further comprising at least one awning bar accessory configured to magnetically attach to the power track and receive power from the power track.

18. The awning bar system of claim 16, further comprising at least one awning bar accessory configured to magnetically attach to at least one of the first power track and second power track and receive power from the at least one of the first power track and second power track.

19. The awning bar kit of claim 14, wherein the at least one awning bar accessory includes at least one of a camera, speaker, light, banner, motion sensor, projector, charging dock, mobile hot spot device, and antenna.

20. The awning bar system of claim 15, wherein the at least one awning bar accessory includes at least one of a camera, speaker, light, banner, motion sensor, projector, charging dock, mobile hot spot device, and antenna.

21. The awning bar system of claim 16, wherein the at least one awning bar accessory includes at least one of a camera, speaker, light, banner, motion sensor, projector, charging dock, mobile hot spot device, and antenna.
